(19) United States
(12) Patent Application Publication
(10) Pub. No.: US 2015/0048550 A1
(43) Pub. Date: Feb. 19, 2015

(54) INJECTION MOLDING MACHINE WITH IMPROVED OUTPUT

(71) Applicant: OTTO MANNER INNOVATION GMBH, Bahlingen am (DE)

(72) Inventor: Ulrich Kaczmarek, Emmendingen (DE)

(21) Appl. No.: 14/454,065

(22) Filed: Aug. 7, 2014

(30) Foreign Application Priority Data
Aug. 13, 2013 (DE) 10 2013 216 008.9
Aug. 13, 2013 (DE) 10 2013 216 013.5

(51) Int. Cl. B29C 45/04; B29C 45/17

(52) U.S. Cl. CPC B29C 45/0416; B29C 45/17; B29C 2045/1796
USPC 264/297.2; 425/575

(57) ABSTRACT

An injection molding machine comprised of an injection unit, a first tool plate and a second tool plate wherein at least the first or the second tool plate is adapted to be moveable along a first axis and at least one form tool having at least one first tool portion and a second tool portion which conjointly form a first cavity in a closed position and which have a gating system for forming at least one molded part, the gate system being communicating with or being interconnectable to a machine nozzle wherein the second tool portion is movable along a second axis disposed substantially perpendicular to the first axis.

### BACKGROUND

The present invention relates to an injection molding machine comprised of an injection molding station and a fixed mold plate and a mold plate moveable along a first axis and having at least one form tool comprised of a first tool portion and a second tool portion where the second tool portion is movable along a second axis arranged substantially perpendicular to the first axis.

In the injection molding process of in particular small parts with thermal critical plastics, a short residence time of the resin in the plasticizing unit, is very important for the manufacture of high quality molded parts. One way to shorten the residence time is to shorten the cycle time. Depending on further constraints of the molding process often this is only possible to a limited extent. A further possibility is a form tool with a gate system with a large volume, for increasing the output of material. The disadvantage here is the sprue formed at the molded part which has to be removed. In some fields of application as in the medicine technology the use of gate systems with a large volume is undesirable because of quality aspects.

To achieve high quality products valve gated hot runner systems are state of the art. However, the additional volume of a hot runner system leads to an even more prolonged residence time of the plasticized material prior to the injection operation, which in turn can result in a loss of quality of the molded part.

### RELATED APPLICATIONS

This application claims the benefit of priority under 35 USC Sections 119 and 120 to German (DE) application serial no. 10 2013 216 008.9 filed Aug. 13, 2013, the disclosure of which is incorporated herein by reference in its entirety as if fully set forth herein.

This application claims the benefit of priority under 35 USC Sections 119 and 120 to German (DE) application serial no. 10 2013 216 013.5 filed Aug. 13, 2013, the disclosure of which is incorporated herein by reference in its entirety as if fully set forth herein.

The disclosures of all of the following are incorporated by reference in their entirety as if fully set forth herein: US Application publication no. 2013/0095202, US Application publication no. 2013/0306686, US Application publication no. 2014/0037779, US Application publication no. 2014/0042148, US Application publication no. 2013/0216645, US Application publication no. 2013/0209603, US Application publication no. 2013/0202728, US Application publication no. 2013/0095202, US Application publication no. 2013/0034621, US Application publication no. 2010/0047379, US Application publication no. 2007/0054004, US Application publication no. 2006/0257521, US Application publication no. 2006/0099296, US Application publication no. 2006/0088619, US Application publication no. 2004/0009259.

### SUMMARY OF THE INVENTION

It is therefore an object of the invention to shorten the residence time of the plasticized material prior to the injection operation.

In accordance with the invention there is provided an injection molding machine comprising an injection unit having a chamber for injection of a plasticized material and a piston for advancing a predetermined amount of plasticized material out of the chamber where the amount of the plasticized material injected is preferably adjustable via a machine controller having a circuit or program that uses a variable representative of one or more of the volume, geometry, temperature and structure of the cavity of the form tool. The injection molding machine is comprised of a first tool plate and a second tool plate, wherein at least the first or the second tool plate is adapted to be moveable along a first axis. The injection molding machine preferably further has a machine nozzle connected to the chamber of the injection unit via which plasticized material can be routed from the injection unit into a cavity.

The injection molding machine is typically comprised of at least one form tool having at least one first tool portion and one second tool portion, which conjointly form a first cavity in a closed position and have a gate system for forming at least one molded part, whereas the gate system is connectable to the machine nozzle and whereas the second tool portion is moveable in the direction of a second axis, which is arranged substantially perpendicular to the first axis.

A machine according to the invention preferably enables transporting of a second tool portion in an injection unit where the first tool portion with at least one further tool portion forms a first cavity, in which plasticized molding material can be introduced from the chamber of the respective injection unit.

In a preferred embodiment the injection molding machine comprises at least one third tool portion, which conjointly with the fixed tool portion forms a second cavity in a closed position, which differs from the first cavity. By this configuration, it is possible to form a second cavity by the use of a third tool portion and to produce second molded parts which differ from the first molded parts. It is also possible to form the second cavity with a volume as large as possible in order to remove a volume as large as possible of plasticized material from the chamber of the injection unit. This is especially useful if the residence time of plasticized material within the chamber tool is so long that thermal damage of the plasticized material is expectable when manufacturing molded parts in the first mold.

Preferably the at least one third tool portion is moveable along the second axis. In this embodiment, the third tool portion—which has preferably the same external geometry as the second tool portion—is simply introduced into the production process of the injection molding machine, preferably in a specially designed station on a transport device or positioned in the injection station via a robot along a three-dimensional path in space. Additional means—apart from a possible change of the injected volume of the plasticized material—are not required here.

Preferably the at least one third tool portion is moveable along a robot axis. In this embodiment the third tool portion is positioned in the injection station by means of a robot, and after closing of the form tool melt is introduced into the cavity formed in the form tool. After opening of the form tool, the third tool portion is brought to a position outside the injection station preferably also by means of the robot, where the plasticized material in the third tool portion solidifies and can finally be removed from the third tool portion.

Preferably the second cavity has a larger volume than the first cavity, whereby molded part with different volumes are producible and in particular different amounts of plasticized material can be brought out of the chamber of the injection unit.

Preferably the injection unit is connectable to two openings of the gate system of the first movable tool portion, for forming at least two molded parts with different volume. In this embodiment, different molded parts can be formed in a cavity of a mold, which can be connected via preferably two openings of the gating system to the injection unit. Preferably in this embodiment the number and volume of the molded parts may vary.

Preferably the second and—if available the third—tool portion comprises a RFID-Transponder. Most preferably the data stored thereon relates in particular to the volume of the cavity, which is used for controlling the injection amount of the injection unit. Likewise, other data may be stored thereon, which is used by other stations of the injection molding machine.

In another aspect of the invention there is provided a method for injection molding of molded parts, the method comprising using an injection molding machine as described above. Such a method typically comprises:
transporting a second tool portion in the direction of the second axis to the injection station of the injection molding machine,
closing the form tool in the direction of the first axis for forming a first cavity,
introducing plasticized material into the cavity of the form tool, for forming first molded parts,
transporting the second tool portion in the direction of the second axis out of the injection station of the injection molding machine,
   wherein the preceding steps can be repeated several times in succession and:
transporting a third tool portion to the injection station of the injection molding machine,
closing the form tool in the direction of the first axis for forming a second cavity, which has a significantly larger volume than the first cavity,
introducing plasticized material into the second cavity of the form tool, for forming second molded parts,
opening of the form tool along the first axis,
transporting the third tool portion out of the injection station of the injection molding machine.

In such a method, the first molded parts are formed in a first form tool and then second molded parts are formed in a second form tool, wherein the mold has an equal first tool portion in each case. These method steps can be carried out several times in succession, and in particular it is possible to transport in succession a plurality of second tool portions in the injection molding station for forming molded parts before a third tool portion is transported to the injection station.

In another aspect of the invention there is provided a method of producing molded parts comprising:
transporting a second tool portion in the direction of the second axis to the injection station of the injection molding machine,
closing the form tool in the direction of the first axis, for forming a first cavity,
introducing plasticized material into the cavity of the form tool, for forming molded parts,
transporting the second tool portion in the direction of the second axis out of the injection station of the injection molding machine,
   wherein the preceding steps can be carried out several times in succession and:
transporting a third tool portion to the injection station of the injection molding machine,
closing the form tool in the direction of the first axis, for forming a second cavity, which has a significantly larger volume than the first cavity,
introducing plasticized material into the second cavity of the form tool,
opening of the form tool in the direction of the first axis,
transporting the third tool portion out of the injection station of the injection molding machine.

This further method differs from the first described method in that although second molded parts are formed in a second mold, but the second molded parts, however, have a much larger volume than the first molded parts made with the first mold. This alternative method is preferably used to remove in particular a larger amount of plasticized material from the chamber of the injection unit by means of the third tool portion in order to substantially reduce the residence time of the plasticized material within said chamber.

Preferably the third tool portion is transported along a robot axis to the injection molding station and is transported out of the injection molding station along a robot axis as the solidification process of the plasticized material in the (sub-) cavity of the third tool portion takes significantly more time than the solidification of the molded part in the (sub-) cavity of a second tool portion. A transport of the third tool portion to the different stations of the injection molding machine along the transport system is therefore less useful.

In another aspect of the invention there is provided an injection molding machine (1) comprising:
an injection unit (15) having a chamber (25) for injecting a plasticized material to a cavity of a tool or mold and a piston (35), for advancing a predetermined amount of the plasticized material out of the chamber (25),
a first tool plate (14) and a second tool plate (26), wherein at least the first or the second tool plate (14, 26) is adapted to be moveable along a first axis (A1),
a machine nozzle communicating with or interconnected to the chamber (25) of the injection unit (15),
at least one form tool (6, 28) having at least one first tool portion (28) and one second tool portion (6) which conjointly form a first cavity (18) in a closed position, the first and second tool portions having a gate system for forming at least one molded part (16), the gate system being interconnectable to the machine nozzle, the second tool portion (6) being moveable along a second axis (A2) which is arranged substantially perpendicular to the first axis (A1).

The machine typically further comprises at least a third tool portion (7) which conjointly with the first tool portion (28) forms a second cavity (19) in a closed position, the second cavity being different from the first cavity (18). The third tool portion (7) is preferably moveable along the second axis (A2). The third tool portion (7) is most preferably moveable along a robot axis. The second cavity (19) typically has a larger volume than the first cavity (18).

The injection unit (15) is preferably interconnectable to or communicates with at least two openings or apertures of the gate system of the first movable tool portion (6) for forming at least two molded parts having different volumes.

The second tool portion (6) preferably includes an RFID-Transponder. The third tool portion (7) preferably includes an RFID-Transponder.

In another aspect of the invention there is provided a method for injection molding molded parts (16, 17) employing an injection molding machine (1) as described above, the method comprising:
transporting the second tool portion in the direction of the second axis (A2) to the injection station (3) of the injection molding machine (1),
closing the form tool (6, 29) along the first axis (A1) to form a first cavity (18),
injecting plasticized material into the cavity (18) of the form tool (6, 29) to form first molded parts (16),
transporting the second tool portion (6) along the second axis (A2) out of an injection station (3) of the injection molding machine (1),
   and:
transporting a third tool portion (7) to the injection station (3) of the injection molding machine (1),
closing the form tool (7, 29) along the first axis (A1) to form a second cavity (19) having a substantially larger volume than the first cavity (18),
injecting plasticized material into the second cavity (19) of the form tool (7, 29) to form second molded parts (17),
opening the form tool (7, 29) along the first axis (A1), and
transporting the third tool portion (7) out of the injection station (3) of the injection molding machine (1).

In another aspect of the invention there is provided a method for injection molding of molded parts (16, 17) employing the injection molding machine described above, the method comprising:
transporting the second tool portion (6) along the second axis (A2) to an injection station (3) of the injection molding machine (1),
closing the form tool (6, 29) along the first axis (A1) to form a first cavity (18),
injecting plasticized material into the cavity (18) of the form tool (6, 29) to form molded parts (16),
transporting the second tool portion (6) along the second axis (A2) out of the injection station (3) of the injection molding machine (1),
   and,
transporting a third tool portion (7) to an injection station (3) of the injection molding machine (1),
closing the form tool (7, 29) along the first axis (A1) to form a second cavity (19) having a substantially larger volume than the first cavity (18),
injecting plasticized material into the second cavity (19) of the form tool (7, 29),
opening the form tool (7, 29) along the first axis (A1),
transporting the third tool portion (7) out of the injection station (3) of the injection molding machine (1).

Such a method typically further comprises transporting the third tool portion (7) along a robot axis to the injection molding station and out of the injection molding station (3).

Further advantages, features and application possibilities of the present invention will become apparent from the following description taken in conjunction with the figures.

### BRIEF DESCRIPTION OF THE DRAWINGS

FIG. 1 is a schematic top plan view of an injection molding machine according to the invention;

FIG. 2 is a schematic top plan view of an alternative embodiment of an injection molding machine according to the invention.

FIG. 3 is a schematic side view of an alternative embodiment of an injection molding machine according to the invention.

FIG. 4a is a schematic view of an exemplary second tool portion component used in a machine according to the invention.

FIG. 4b is a schematic representation of an exemplary third tool portion used in a machine according to the invention.

FIG. 5a is a side schematic view of an injection unit arranged in position for injection to a first tool for making first parts.

FIG. 5b is a side schematic view an injection unit arranged in position for injection to a second tool for making second parts.

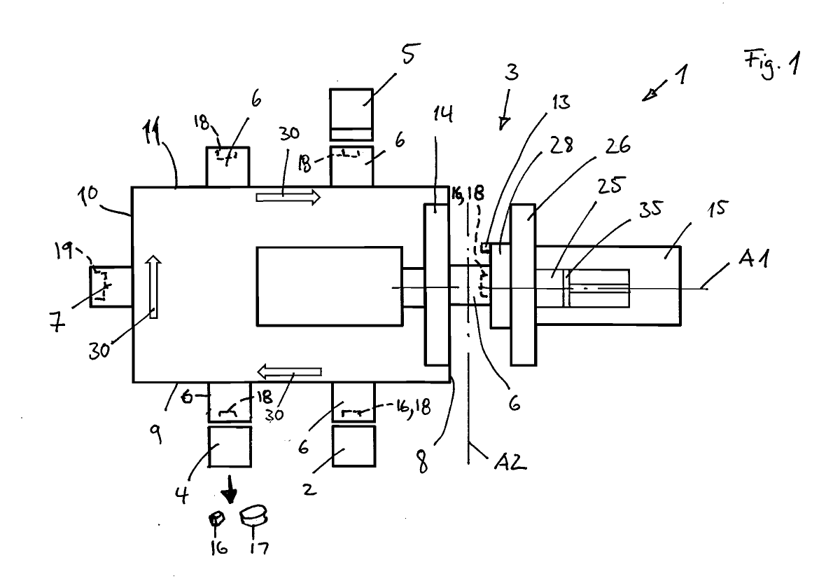

FIG. 1 shows a schematic representation of an exemplary injection molding machine 1 in a plan view. The injection molding machine 1 includes a plurality of second tool portions 6, which form conjointly with a first tool portion 28 a first cavity in a closed position. The injection molding machine 1 further comprises an injection unit 15 having a chamber 25 for a plasticized material and a piston 35, to advance a first amount of plasticized material out of the chamber. Vis-à-vis of the injection unit 15 a transport means 8 is arranged at a second tool plate 14, at which a second tool portion 6 is arranged moveable in the direction of a second axis A2.

Vis-à-vis to this second tool portion 6, a first tool portion 28 is fixed to a first tool plate 26. The first tool portion 28 comprises a gate system into which plasticized material is insertable by means of a machine nozzle of the injection unit 15.

The form tool is in the closed position when the second tool plate 26 with the second tool portion 28 is pressed in the direction of the first axis A1 to the first tool portion 6 at the first tool plate 14. Then also the cavity 18 is closed which is formed by the first tool portion 28 and the second tool portion 6. Plasticized material flowing through the gating system can hereby fill the entire space of the cavity 18.

At the second transport means 9 a station designed as cooling station 2 is arranged. The cooling station 2 serves for cooling of the second tool portion 6, and in particular for cooling of the at least one tool portion 16 arranged in the cavity. At the second transport means 9 as further station a demolding station 4 is located, in which the molded parts 16 (which are still arranged in the (partial) cavity 18 of a second tool portion 6) are demolded from the (partial) cavity 18 of a second tool portion 6 which is located in the demolding station 4.

As further shown in FIG. 1, at the left side of the second transport means 9 a third transport means 10 is arranged and at the right side of this, parallel to the second transport means 9 a fourth transport means 11 is arranged. The various transport means 8, 9, 10 and 11 are arranged to each other respectively at an angle of about 90 degrees.

At the fourth transport means 11 a further station designed as a heating station 5 is located. By means of the heating station 5 a second tool portion 6 arranged there is preheated to a desired temperature for the next injection operation.

With the first transport means 8, the respective second tool portion 6 is initially transported into the injection station 3. As soon as the second tool portion 6 has reached a predetermined position in the injection station 3, the form tool is brought into the closed position. At the same time it is ensured that the second tool portion 6 is at an exact position in the injection station 3 for performing the injection molding operation.

At the exemplary injection molding machine 1 further a third tool portion 7 is arranged which forms conjointly with the first tool portion 28 a second cavity 19 in a closed position, which is different from the first cavity 18. The outer geometry of the third tool portion 7 does not differ from the geometry of a second tool portion 6, so that the second and third tool portions 6, 7 are movable in the same manner by the transport means 8, 9, 10, 11.

In each case one second or third tool portion 6, 7 is movable in each case at a transport means 8, 9, 10, 11 independently of the other second and third tool portions 6, 7 at another, or at the same transport means 8, 9, 10, 11. The second or third tool portions 6, 7 arranged on the injection molding machine 1 can be moved in each case independent of time and about an individual distance at the transport means 8, 9, 10, 11. The injection molding machine can also be designed in a way, that at least two second and third tool portions 6, 7 are moved at least simultaneously and/or the same distance in particular when these are arranged on the same transport means 8, 9, 10, 11. The transport means 8, 9, 10, 11 is designed in a way, that the second and third tool portions 6, 7 are each moved from one transport means 8, 9, 10, 11 to the next transport means 8, 9, 10, 11. The preferred direction of movement of the tool portions 6, 7 on the transport means 8, 9, 10, 11 is shown in FIG. 1 by the arrows 30. During the movement of a second or third tool portion 6, 7 by a transporting means 8, 9, 10, 11 in the direction of the arrows 30 to the next transporting means 9, 10, 11, 8, the second or third tool portions 6, 7 are preferably rotated clockwise.

In a preferred embodiment of the injection molding machine 1, wherein the volume of the second cavity is different from the volume of the first cavity, a RFID transponder is arranged at the second and/or third tool portions 6, 7. The data stored thereon, relates also in particular to the volume of the cavity, which is used by a RFID reader 13 arranged at the injection station 3 for controlling the injection amount of the injection unit 15. Also, RFID readers may be arranged at subsequent stations to read data stored thereon in order to control the operations performed in these stations depending on the movable second or third tool portion 6, 7 which is positioned there.

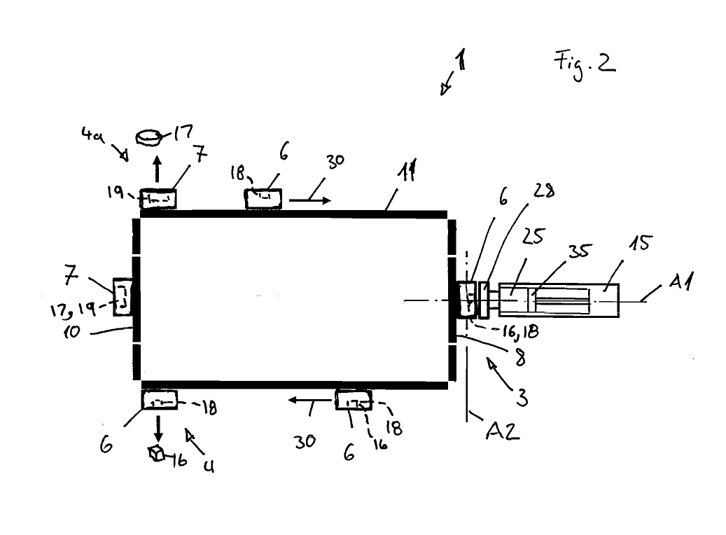

FIG. 2 shows a schematic representation of another exemplary injection molding machine 1 in a top plan view. Like elements compared with the injection molding machine 1 of FIG. 1 are indicated with like reference numerals. The injection molding machine 1 in FIG. 2 differs from the injection molding machine in FIG. 1 by the different demolding stations 4, 4a of the molded parts 16 and 17. Within the second tool portion 6 a molded part 16 is arranged after the injection operation in the injection station 3 and within the third tool portion 7 a molded part 17 is arranged after the injection operation in the injection station 3.

Depending on the required solidification time of the molded parts 16, 17, which is in particular dependent on the volume, the design as the ratio of the surface area to the volume and on the cooling operation, one molded part 16, 17 can be removed earlier from a third tool portion 7 than another molded part 16, 17. Therefore, the injection molding machine 1 in FIG. 2 comprises two demolding stations 4 and 4a. In the exemplary injection molding machine 1, the molded part 16 is removed in the first demolding station 4 from the second tool portion 6 and in the second demolding station 4a, which is arranged after the first demolding station 4 along the transport path 8, 9, 10, 11, the molded part 17 is removed from the third tool portion 7.

If a RFID transponder is disposed at the second and third tool portions 6, 7, then the data contained thereon can be read by means of a RFID reader arranged at the demolding stations 4, 4a, whether the corresponding molded part 16, 17 has to be demolded from the second or third tool portion 6, 7 at the respective demolding station 4, 4a. In the same way at the demolding stations 4, 4a can be detected by means of a sensor if the molded part has to be demolded there. Such a sensor may in particular be formed by a visual system, such as a camera or by a mechanical system such as a push-button.

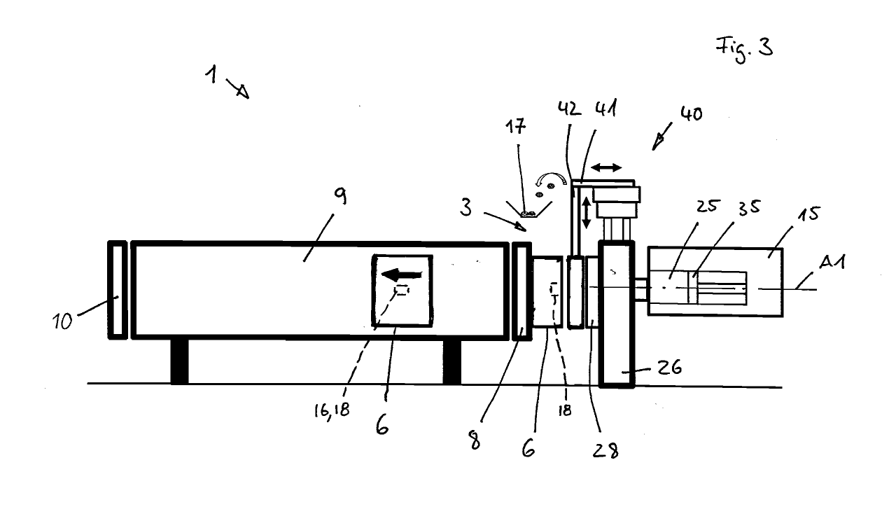

FIG. 3 shows another schematic representation of another exemplary injection molding machine 1 in side view. Like elements compared with the injection molding machine 1 of FIG. 1 are indicated with like reference numerals. The injection molding machine 1 in FIG. 3 differs from the injection molding machine 1 in FIG. 1 in that on the transport device 8, 9, 10, 11 only second tool portions 6 are transported. In this embodiment a third tool portion 7 is inserted into the injection station 3 by means of a robot 40.

The robot 40 of the exemplary injection molding machine 1 is configured as a portal robot and has at least one horizontal guide 41 and a vertical guide 42 by means of which the third tool portion 7 can be positioned vis-à-vis the first tool portion 28 in the injection station 3. Similarly, the robot could be configured as a jointed-arm robot 40, by means of which the third tool portion 7 can be positioned from an initial position along a three-dimensional path in the target position vis-à-vis the first tool portion 28 in the injection station 3.

When the third tool portion 7 is positioned vis-à-vis the first tool portion 28 in the injection station 3, the form tool 7, 28 comprising the first 28 and third 7 tool portions is brought in the closed position by sliding the movable tool plate 26 by means of a closing device in the direction of the axis A1 whereby the second cavity 19 is closed. By means of the piston 35 plasticized material from the chamber 25 of the injection unit 15 is then introduced under pressure in the cavity 19 which is completely filled. In the exemplary embodiment, the second cavity 19 has a larger volume than the first cavity 18 of the form tool 28, 6, so that by means of the third mold tool 7, a comparatively large amount of plasticized material can be removed from the chamber 25 of the injection unit 15.

After opening of the form tool 28, 7, the third tool portion 7 is moved to a rest position by the robot 40 in which the molded parts 17 solidify in the (partial) cavity of the third tool portion 7. After a sufficient cooling period, the molded parts 17 are taken out of the third tool portion 7 by means of a suitable demolding device as is shown in FIG. 3.

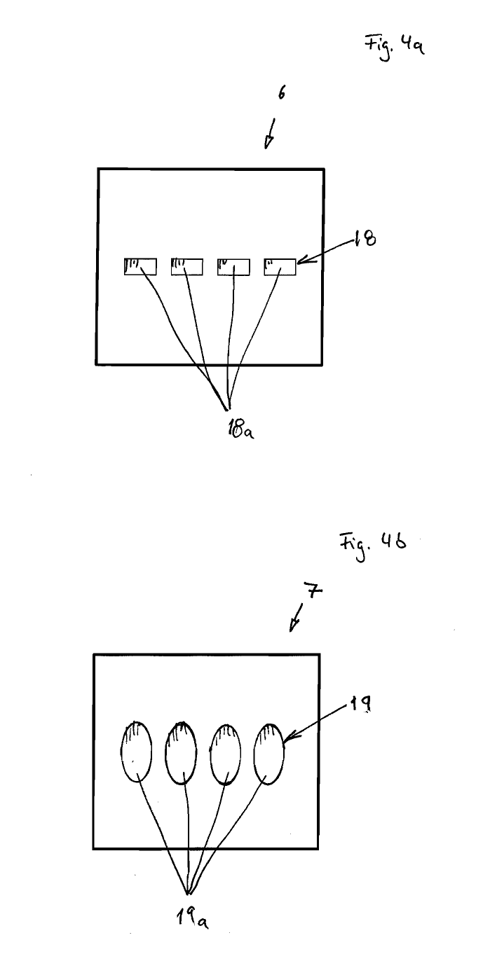

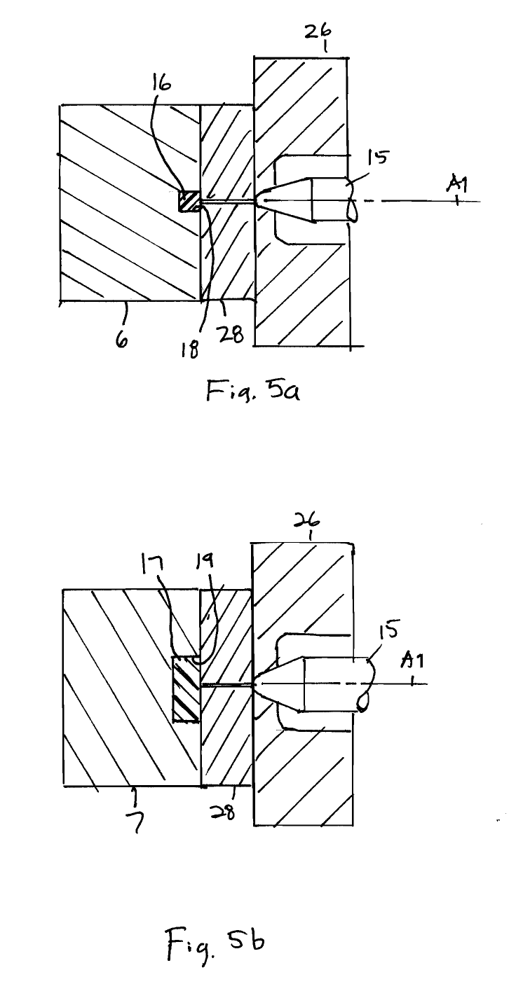

FIG. 4a shows an exemplary second tool portion 6, which forms with a first tool portion 28 a form tool 6, 28 within which a cavity 18 is formed in a closed position. At least a portion of the cavity 18 is disposed in the second tool portion 6, which is indicated by 18a in FIG. 4a. The cavity 18 of the form tool 6, 28 has four separate mold cavities, in which four separate molded parts 16 are formed. Since the molded parts 16 have a relatively small volume, there is a risk that the plasticized material remains too long within the chamber 25 of the injection unit 15 and may be thermally damaged as a result.

FIG. 4b shows an exemplary third tool portion 7, which forms with a first tool portion 28 a form tool 6, 28 within which a cavity 19 is formed in a closed position. At least a portion of the cavity 19 is disposed in the third tool portion 7, which is indicated by 19a in FIG. 4b. The cavity 19 of the form tool 7, 28 comprises four separate mold cavities, in which four separate molded parts 17 are formed. The molded parts 17 have a significantly larger volume than the molded parts 16 of the form tool 6, 28. By means of an injection operation using the form tool 7, 28 a significantly larger amount of plasticized material can be removed from the chamber 25 of the injection unit 15. By using the third tool portion 7, it is possible to shorten the residence time of the plasticized material in the injection unit 15.

What is claimed is:

1. An injection molding machine comprising:
an injection unit having a chamber for injecting a plasticized material to a cavity of a tool or mold and a piston, for advancing a predetermined amount of the plasticized material out of the chamber,
a first tool plate and a second tool plate, wherein at least the first or the second tool plate is adapted to be moveable along a first axis,
a machine nozzle communicating with or interconnected to the chamber of the injection unit,
at least one form tool having at least one first tool portion and one second tool portion which conjointly form a first cavity in a closed position, the first and second tool portions having a gate system for forming at least one molded part, the gate system being interconnectable to the machine nozzle, the second tool portion being moveable along a second axis which is arranged substantially perpendicular to the first axis.

2. The Injection molding machine according to claim 1 further comprising at least a third tool portion which conjointly with the first tool portion forms a second cavity in a closed position, the second cavity being different from the first cavity.

3. The injection molding machine according to claim 2 wherein the third tool portion is moveable along the second axis.

4. The Injection molding machine according to claim 2 wherein the third tool portion is moveable along a robot axis.

5. The injection molding machine according to claim 2 wherein the second cavity has a larger volume than the first cavity.

6. The injection molding machine of claim 1 wherein the injection unit is interconnectable to at least two openings or apertures of the gate system of the first movable tool portion for forming at least two molded parts having different volumes.

7. The injection molding machine according to claim 1 wherein the second tool portion comprises an RFID-Transponder.

8. The injection molding machine according to claim 1 wherein the third tool portion comprises an RFID-Transponder.

9. A method for injection molding molded parts employing an injection molding machine of claim 1, the method comprising:
transporting the second tool portion in the direction of the second axis to the injection station of the injection molding machine,
closing the form tool along the first axis to form a first cavity,
injecting plasticized material into the cavity of the form tool to form first molded parts,
transporting the second tool portion along the second axis out of an injection station of the injection molding machine,
and:
transporting a third tool portion to the injection station of the injection molding machine,
closing the form tool along the first axis to form a second cavity having a substantially larger volume than the first cavity,
injecting plasticized material into the second cavity of the form tool to form second molded parts,
opening the form tool along the first axis, and
transporting the third tool portion out of the injection station of the injection molding machine.

10. A method for injection molding of molded parts employing the injection molding machine of claim 1, the method comprising:
transporting the second tool portion along the second axis to an injection station of the injection molding machine,
closing the form tool along the first axis to form a first cavity,
injecting plasticized material into the cavity of the form tool to form molded parts,
transporting the second tool portion along the second axis out of the injection station of the injection molding machine,
and,
transporting a third tool portion to an injection station of the injection molding machine,
closing the form tool along the first axis to form a second cavity having a substantially larger volume than the first cavity,
injecting plasticized material into the second cavity of the form tool,
opening the form tool along the first axis,
transporting the third tool portion out of the injection station of the injection molding machine.

11. The method of claim 10 further comprising transporting the third tool portion along a robot axis to the injection molding station and out of the injection molding station.
